(19) United States
(12) Patent Application Publication
(10) Pub. No.: US 2025/0363833 A1
(43) Pub. Date: Nov. 27, 2025

(54) VEHICLE DTE INFORMATION PROVIDING SYSTEM AND METHOD THEREFOR

(71) Applicants: HYUNDAI MOTOR COMPANY, Seoul (KR); Kia Corporation, Seoul (KR)

(72) Inventors: Kyeong Soo SONG, Hwaseong-si (KR); Yong Kak CHOI, Hwaseong-si (KR); Yong Chan KIM, Hwaseong-si (KR); Seung Jae YOO, Hwaseong-si (KR); Hyun Jong HA, Hwaseong-si (KR)

(73) Assignees: HYUNDAI MOTOR COMPANY, Seoul (KR); Kia Corporation, Seoul (KR)

(21) Appl. No.: 18/947,636

(22) Filed: Nov. 14, 2024

(30) Foreign Application Priority Data
May 24, 2024 (KR) 10-2024-0067857

(51) Int. Cl. G07C 5/00; G06F 3/14; G07C 5/04

(52) U.S. Cl. CPC G07C 5/004; G07C 5/04; G06F 3/14

(57) ABSTRACT

A vehicle Distance to Empty (DTE) information providing system includes a display device that displays DTE information of a vehicle, and a controller that controls an operation of the display device, in which the controller respectively determines low fuel economies and high fuel economies for different current fuel economies to store the results in a fuel economy map, determines a current DTE value, which is a real-time DTE based on a current fuel economy, based on a current battery SOC value, determines a low DTE value and a high DTE value of the current DTE value using the fuel economy map, and displays the result on the display device, selectively converts the low DTE value and the high DTE value in a case where the current DTE value reaches the low DTE value or the high DTE value, and displays the result.

### CROSS-REFERENCE TO RELATED APPLICATION

The present application claims priority to Korean Patent Application No. 10-2024-0067857 filed on May 24, 2024, the entire contents of which is incorporated herein for all purposes by this reference.

### BACKGROUND OF THE PRESENT DISCLOSURE

Field of the Present Disclosure

the present disclosure relates to a vehicle Distance To Empty (DTE) information providing system and a method thereof, and more specifically, to a vehicle DTE information providing system and a method therefor, configured for displaying DTE information of an electric vehicle on a display device such as a cluster for a driver.

### Description of Related Art

In general, a vehicle provides a function of predicting a distance to empty (referred to hereinafter as DTE) and informing a driver of the result. For example, an internal combustion engine vehicle provides a function of predicting DTE based on a fuel level in a fuel tank and informs the driver of the result through a cluster or the like.

Similarly, an electric vehicle that runs by driving a motor with battery power estimates DTE based on a current battery State of Charge (SOC) and displays the result on a cluster provided in the vehicle.

In the case of the electric vehicle, since the number of charging stations is relatively small and charging time is relatively long compared with the internal combustion engine vehicle, a driver is highly interested in DTE of the electric vehicle.

In the present way, as the driver is sensitive to the DTE in the electric vehicle, it is desirable that the vehicle accurately calculate the DTE corresponding to the battery SoC in real time while driving and inform the driver of the result.

To provide DTE information in a vehicle, a technique for estimating DTE using a relationship between battery SOC value and energy efficiency (electricity consumption) has been provided. For example, a technique of determining energy efficiency using information accumulated from the past and then multiplying the determined energy efficiency by a current battery SoC to determine DTE, is generally known.

Furthermore, a technique for applying weighted factors to the past DTE and DTE on a current route and combining the results to determine a final DTE, and adjusting the determined DTE according to occurrence of an event using information accumulated from the past and forward event information, is generally known.

Generally, the DTE is determined using past energy efficiency to remove uncertainty in future driving prediction information, but this is applicable under the assumption that the past energy consumption trend will be continuously maintained in the future. However, in a case where future traffic conditions show different aspects from past driving information, a large error may occur in the energy efficiency based on the past information.

Generally, the DTE is updated whenever an event that consumes energy occurs, which may result in the impact of the event being over-represented or under-represented on the remaining driving path.

Furthermore, various techniques for estimating or predicting the DTE have been provided, and in general, vehicle manufacturers estimate or predict the DTE using their own methods and display the result to a driver through a cluster.

However, since it is difficult to increase the prediction accuracy for the DTE, there are many quality complaints related to prediction accuracy. To cope with these complaints, a technique for providing a minimum (MIN) DTE and a maximum (MAX) DTE with a current DTE through a cluster has been provided.

However, in the present technique, the minimum DTE and the maximum DTE trained based on recent driving conditions in a state where a driver's future driving tendency cannot be accurately predicted tend to fluctuate significantly, which does not match the meaning of the DTE for predicting a future DTE.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a vehicle Distance to Empty (DTE) information providing system and a method therefor, configured for continuously providing fuel economy guidance to a driver by determining a low fuel economy and a high fuel economy for a plurality of different fuel economy driving levels with reference to a current fuel economy, inputting the results to a vehicle control unit (VCU), converting, in a case where a DTE based on the current fuel economy reaches a low DTE or a high DTE corresponding to the low fuel economy and the high fuel economy, the fuel economy driving level downward or upward, and outputting the low DTE and the high DTE at the converted fuel economy driving level.

In one aspect, the present disclosure provides a vehicle Distance to Empty (DTE) information providing system including a display device that displays DTE information of a vehicle, and a controller that is operatively connected to the display device and configured to control an operation of the display device, in which the controller is configured to determine low fuel economies and high fuel economies for different current fuel economies to store the results in a fuel economy map, to determine a current DTE value, which is a real-time DTE based on a current fuel economy, based on a current battery SOC value, to determine a low DTE value and a high DTE value of the current DTE value using the fuel economy map, and displays the result on the display device, selectively to convert the low DTE value and the high DTE value in a case where the current DTE value reaches the low DTE value or the high DTE value, and displays the result.

In an exemplary embodiment of the present disclosure, the controller may be configured to determine the low fuel economy and the high fuel economy according to the current fuel economy based on first, second, third, fourth and fifth fuel economy driving levels sequentially disposed according to the current fuel economy, and store the result in the fuel economy map.

In another exemplary embodiment of the present disclosure, the controller may perform control for converting, in a case where the current DTE value of the current fuel economy corresponding to the third fuel economy driving level reaches the high DTE value, the third fuel economy driving level to the second fuel economy driving level, and displaying the low DTE value and the high DTE value of the second fuel economy driving level on the display device.

In yet another exemplary embodiment of the present disclosure, the controller may perform control for displaying, in a case where the third fuel economy driving level is converted to the second fuel economy driving level, information related to a state of the conversion on the display device.

In yet another exemplary embodiment of the present disclosure, the controller may perform control for displaying the information related to the state of the conversion using one or more display methods among a message, a display position of a graphic, a size of the graphic, and a color of the graphic.

In still yet another exemplary embodiment of the present disclosure, the controller may perform control for converting, in a case where the current DTE value of the current fuel economy corresponding to the third fuel economy driving level reaches the low DTE value, the third fuel economy driving level to the fourth fuel economy driving level, and displaying the low DTE value and the high DTE value of the fourth fuel economy driving level on the display device.

In a further exemplary embodiment of the present disclosure, the controller may perform control for displaying, in a case where the third fuel economy driving level is converted to the fourth fuel economy driving level, information related to the state of the conversion on the display device.

In another further exemplary embodiment of the present disclosure, the controller may display the information related to the state of the conversion using one or more display methods among a message, a display position of a graphic, a size of the graphic, and a color of the graphic.

In yet another further exemplary embodiment of the present disclosure, the controller may be configured to control, in a case where the current DTE value of the current fuel economy corresponding to the first fuel economy driving level reaches a high DTE value, the display device to follow and display the current DTE value.

In yet another further exemplary embodiment of the present disclosure, the controller may be configured to control, in a case where the current DTE value of the current fuel economy corresponding to the fifth fuel economy driving level reaches a low DTE value, the display device to follow and display the current DTE value.

In still yet another further exemplary embodiment of the present disclosure, the controller may be configured for controlling the display device to display which fuel economy driving level among the first, second, third, fourth and fifth fuel economy driving levels the current DTE value of the current fuel economy corresponds to.

In another aspect, the present disclosure provides a vehicle DTE information providing method, the method including determining low fuel economies and high fuel economies for different current fuel economies to store the results in a fuel economy map, by a controller, determining a current DTE value, which is a real-time DTE based on a current fuel economy, based on a current battery SOC value, determining a low DTE value and a high DTE value of the current DTE value using the fuel economy map, and displaying the result on a display device, by the controller, and selectively converting the low DTE value and the high DTE value in a case where the current DTE value reaches the low DTE value or the high DTE value, by the controller.

In another exemplary embodiment of the present disclosure, the controller may be configured to determine the low fuel economy and the high fuel economy according to the current fuel economy based on first, second, third, fourth and fifth fuel economy driving levels sequentially disposed according to the current fuel economy, and store the result in the fuel economy map.

In yet another exemplary embodiment of the present disclosure, the converting of the low DTE value and the high DTE value may include performing control for converting, in a case where the current DTE value of the current fuel economy corresponding to the third fuel economy driving level reaches the high DTE value, the third fuel economy driving level to the second fuel economy driving level, and displaying the low DTE value and the high DTE value of the second fuel economy driving level on the display device, by the controller.

In yet another exemplary embodiment of the present disclosure, the converting of the low DTE value and the high DTE value may include performing control for displaying, in a case where the third fuel economy driving level is converted to the second fuel economy driving level, information related to the state of the conversion on the display device, by the controller.

In still yet another exemplary embodiment of the present disclosure, the converting of the low DTE value and the high DTE value may include performing control for converting, in a case where the current DTE value of the current fuel economy corresponding to the third fuel economy driving level reaches the low DTE value, the third fuel economy driving level to the fourth fuel economy driving level, and displaying the low DTE value and the high DTE value of the fourth fuel economy driving level on the display device, by the controller.

In a further exemplary embodiment of the present disclosure, the converting of the low DTE value and the high DTE value may include performing control for displaying, in a case where the third fuel economy driving level is converted to the fourth fuel economy driving level, information related to the state of the conversion on the display device, by the controller.

In another further exemplary embodiment of the present disclosure, the converting of the low DTE value and the high DTE value may include controlling, in a case where the current DTE value of the current fuel economy corresponding to the first fuel economy driving level reaches a high DTE value, the display device to follow and display the current DTE value, by the controller.

In yet another further exemplary embodiment of the present disclosure, the converting of the low DTE value and the high DTE value may include controlling, in a case where the current DTE value of the current fuel economy corresponding to the fifth fuel economy driving level reaches a low DTE value, the display device to follow and display the current DTE value.

In yet another further exemplary embodiment of the present disclosure, the converting of the low DTE value and the high DTE value may include controlling the display device to display which fuel economy driving level among the first, second, third, fourth and fifth fuel economy driving levels the current DTE value of the current fuel economy corresponds to, by the controller.

Other aspects and exemplary embodiments of the present disclosure are discussed infra.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing a configuration of a vehicle DTE information providing system according to an exemplary embodiment of the present disclosure.

FIG. 2 is a diagram showing a method for determining a low DTE value and a high DTE value, in a vehicle DTE information providing system according to an exemplary embodiment of the present disclosure.

FIG. 3A and FIG. 3B are diagrams showing an example in which a low DTE value and a high DTE value, and a current DTE value are displayed on a cluster of the vehicle, in a vehicle DTE information providing system according to an exemplary embodiment of the present disclosure.

FIG. 4A, FIG. 4B, FIG. 4C, and FIG. 4D are diagrams showing a first example showing conversion of a low DTE value and a high DTE value, in a vehicle DTE information providing system according to an exemplary embodiment of the present disclosure.

FIG. 5A, FIG. 5B, and FIG. 5C are diagrams showing a second example showing conversion of a low DTE value and a high DTE value, in a vehicle DTE information providing system according to an exemplary embodiment of the present disclosure.

FIG. 6A and FIG. 6B are diagrams showing following of a high DTE value, in a vehicle DTE information providing system according to an exemplary embodiment of the present disclosure.

FIG. 7A and FIG. 7B are diagrams showing following of a low DTE value, in a vehicle DTE information providing system according to an exemplary embodiment of the present disclosure.

It should be understood that the appended drawings are not necessarily to scale, presenting a somewhat simplified representation of various exemplary features illustrative of the basic principles of the present disclosure. The specific design features of the present disclosure as included herein, including, for example, specific dimensions, orientations, locations, and shapes locations, and shapes will be determined in part by the particularly intended application and use environment.

In the figures, reference numbers refer to the same or equivalent portions of the present disclosure throughout the several figures of the drawing.

### DETAILED DESCRIPTION

Hereinafter, reference will be made in detail to various embodiments of the present disclosure, examples of which are illustrated in the accompanying drawings and described below. While the present disclosure will be described in conjunction with exemplary embodiments of the present disclosure, it will be understood that the present description is not intended to limit the present disclosure to the exemplary embodiments of the present disclosure. On the other hand, the present disclosure is directed to cover not only the exemplary embodiments of the present disclosure, but also various alternatives, modifications, equivalents and other embodiments, within the spirit and scope of the present disclosure as defined by the appended claims.

In the present description, a low DTE and a high DTE refer to information unrelated to learning, that is, values that vary according to change in a battery State of Charge (SOC) regardless of learning and regardless of a driver's driving type.

According to various exemplary embodiments of the present disclosure, a current DTE value is displayed on a display device such as a cluster, and a low DTE value and a high DTE value determined based on a battery SoC are displayed together with the current DTE value on the display device. A driver may drive a vehicle so that the current DTE value is closer to the high DTE value than the low DTE value, while checking the low DTE value, the high DTE value, and the current DTE value between the low DTE value and the high DTE value in real time while driving.

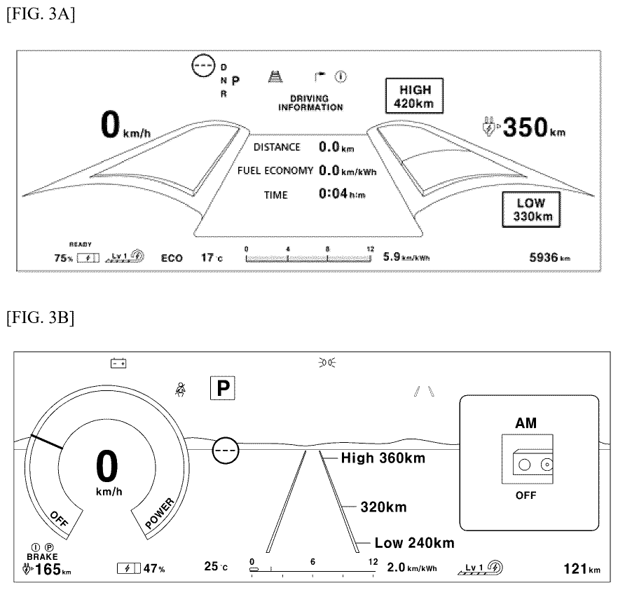

FIG. 3A and FIG. 3B are diagrams showing an example in which a low DTE value and a high DTE value, and a current DTE value are displayed on a cluster of the vehicle.

As shown in the figures, a low DTE value, a high DTE value, and a current DTE value may be displayed on a cluster together with normal display information. For example, the low DTE value, the high DTE value, and the current DTE value may be displayed on the cluster, as information indicating numbers, relative display locations, and relative sizes, together with normal cluster information.

Hereinafter, a method for determining the low DTE and the high DTE will be described.

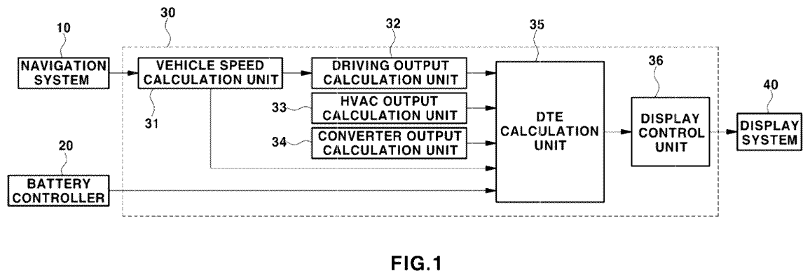

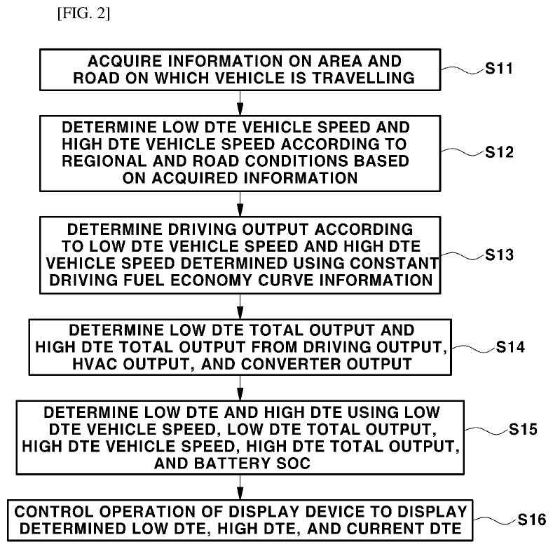

FIG. 1 is a diagram showing a configuration of a DTE information providing system according to an exemplary embodiment of the present disclosure, and FIG. 2 is a diagram showing a method for determining a low DTE value and a high DTE value, in the vehicle DTE information providing system according to the exemplary embodiment of FIG. 1.

Here, a process shown in FIG. 2 is performed by a controller 30 shown in FIG. 1. The controller 30 is configured to determine a low DTE value, a high DTE value, and a current DTE value in real time, and displays the DTE values on a display device 40 for a driver, as shown in FIG. 3A and FIG. 3B.

In an exemplary embodiment of the present disclosure, a control process for providing DTE information may be performed by a plurality of controllers that exchange necessary information with each other through cooperative control, or may be performed by a single integrated controller.

For example, the plurality of controllers may include a vehicle control unit (VCU), a Heating, Ventilation, and Air Conditioning (HVAC) controller, and a battery management system (BMS), which are higher-level controllers, and may further include a converter controller.

Here, the converter controller may be a converter that converts battery power and outputs the result to electrical components of the vehicle, that is, a low voltage DC-DC converter (LDC) controller.

In the present description, the plurality of controllers and the single integrated controller are collectively referred to as a controller. That is, the control process of the present disclosure is performed by the controller.

Referring to FIG. 1, the controller 30, which corresponds to the above-mentioned controller, includes a vehicle speed calculation unit 31, a driving output calculation unit 32, an HVAC output calculation unit 33, a converter output calculation unit 34, a DTE calculation unit 35, and a display control unit 36. In a case where the control process according to the exemplary embodiment of the present disclosure is performed by a plurality of controllers separately provided in the vehicle, the HVAC output calculation unit 33 may be an HVAC controller, and the converter output calculation unit 34 may be a converter controller. Furthermore, the display control unit 36 according to the exemplary embodiment of the present disclosure may be a display controller, which is a separate controller connected to or included in the display device 40 to control an operation of the display device 40.

Furthermore, the vehicle speed calculation unit 31, the driving output calculation unit 32, and the DTE calculation unit 35 may also be components included in a separate controller, for example, a vehicle control unit (VCU).

As described above, the vehicle speed calculation unit 31, the driving output calculation unit 32, and the DTE calculation unit 35, the HVAC controller, the converter controller, and the display controller may be collectively referred to as the controller.

In the exemplary embodiment of the present disclosure, the DTE calculation unit 35 of the controller 30 may be configured to determine a low DTE value and a high DTE value, respectively, using a current battery SoC.

The DTE calculation unit 35 may be configured to determine the low DTE value using low fuel economy-related information and the current battery SOC value, and may be configured to determine the high DTE value using high fuel economy-related information and the current battery SoC.

Here, the low fuel economy-related information includes a low DTE vehicle speed under current vehicle driving conditions, and a low DTE total output which is a total battery output at the low DTE vehicle speed.

Furthermore, the high fuel economy-related information includes a high DTE vehicle speed under the current vehicle driving conditions, and a high DTE total output which is a total battery output at the high DTE vehicle speed.

Accordingly, the DTE calculation unit 35 may be configured to determine the low DTE using the low fuel economy-related information including the low DTE vehicle speed and the low DTE total output, and the current battery SoC.

Furthermore, the DTE calculation unit 35 may be configured to determine the high DTE using the high fuel economy-related information including the high DTE vehicle speed and the high DTE total output, and the current battery SoC.

As described above, the low DTE total output corresponds to the total battery output at the low DTE vehicle speed, and the high DTE total output corresponds to the total battery output at the high DTE vehicle speed.

In an exemplary embodiment of the present disclosure, the low DTE value may be determined by multiplying a value obtained by dividing the low DTE vehicle speed by the low DTE total output by the current battery SOC value, and the high DTE value may be determined by multiplying a value obtained by dividing the high DTE vehicle speed by the high DTE total output by the current battery SoC.

This is expressed as Equation 1 and Equation 2.

$$Low DTE = ( Low DTE vehicle speed ) / ( Low DTE total output ) \times ( Battery SoC ) \qquad [ Equation 1 ]$$

$$High DTE = ( High DTE vehicle speed ) / ( High DTE total output ) \times ( Battery SoC ) \qquad [ Equation 2 ]$$

The low DTE vehicle speed and the high DTE vehicle speed may be determined by the vehicle speed calculation unit 31 of the controller 30 (S12 in FIG. 2). The low DTE vehicle speed and the high DTE vehicle speed are values according to vehicle driving conditions, and may be values preset by the calculation unit 31.

The low DTE vehicle speed and the high DTE vehicle speed are values determined in advance according to regional conditions and road conditions. That is, the vehicle speed calculation unit 31 may be configured to determine the low DTE vehicle speed and the high DTE vehicle speed corresponding to the regional conditions and road conditions.

In a case where the controller 30 that is configured to determine the low DTE value and the high DTE value according to Equations 1 and 2 is a vehicle control unit, the vehicle control unit is configured to receive real-time battery SoC information from the battery management system (BMS) 20 and is configured to determine the low DTE value and the high DTE value using the information.

In an exemplary embodiment of the present disclosure, the vehicle driving conditions may include regional conditions and road conditions in which the vehicle is travelling.

Furthermore, in an exemplary embodiment of the present disclosure, the low DTE vehicle speed refers to a vehicle speed capable of providing a short (low) DTE depending on regional conditions and road conditions, and the high DTE vehicle speed refers to a vehicle speed capable of providing a long (high) DTE depending on regional conditions and road conditions.

In an exemplary embodiment of the present disclosure, the low DTE vehicle speed and the high DTE vehicle speed are determined in advance as values according to regional conditions and road conditions, and accordingly, are stored in the vehicle speed calculation unit 31 of the controller 30 so that the low DTE vehicle speed and the high DTE vehicle speed correspond to each regional condition and each road condition.

Accordingly, the vehicle speed calculation unit 31 of the controller 30 may be configured to determine a low DTE vehicle speed and a high DTE vehicle speed corresponding to an area and a road on which the vehicle is currently travelling based on information on the low DTE vehicle speed and the high DTE vehicle speed set for each regional condition and each road condition.

Here, the information on the area and road on which the vehicle is currently travelling may be obtained by the vehicle speed calculation unit 31 of the controller 30 from navigation information output from a navigation system 10 (S11 in FIG. 2).

That is, the controller 30 may obtain information on a regional condition and a road condition for determining the low DTE vehicle speed and the high DTE vehicle speed from current vehicle location information and current road information among the navigation information input from the navigation system 10.

Table 1 shows an example in which low DTE vehicle speeds and high DTE vehicle speeds are set. Values of the low DTE vehicle speed and the high DTE vehicle speed are merely examples, and accordingly, may be modified in various ways according to regional conditions and road conditions.

TABLE 1

| | |
|---|---|
| Korea, Europe | North America |

| | Low DTE | High DTE | Low DTE | High DTE |
|---|---|---|---|---|
| | vehicle | vehicle | vehicle | vehicle |
| | speed | speed | speed | speed |
| | [km/hr] | [km/hr] | [km/hr] | [km/hr] |
| Highways | 120 | 80 | 130 | 90 |
| City roads | 100 | 60 | 110 | 70 |

As shown in Table 1, highways include a higher average vehicle speed than city roads, and North America includes a higher average vehicle speed than Korea and Europe. In general, since the DTE is proportional to the average vehicle speed, in regional and road conditions where the average vehicle speed is higher, the low DTE vehicle speed and high DTE vehicle speed may be set to higher values.

Referring to Table 1, it may be seen that the low DTE vehicle speed is a vehicle speed capable of achieving a short DTE (low DTE), and thus, is set to a higher vehicle speed than the high DTE vehicle speed capable of achieving a long DTE (high DTE value).

In other words, while driving at high speed, the DTE becomes shorter than while driving at low speed, and therefore, the low DTE vehicle speed capable of achieving a short DTE is set to a higher vehicle speed value than the high DTE vehicle speed capable of achieving a long DTE.

In an exemplary embodiment of the present disclosure, as described above, the low DTE total output and the high DTE total output correspond to the total battery output, and may be determined as the sum of a driving output and an HVAC output, determined by the DTE calculation unit 35 of the controller 30, or may be determined as the sum of the driving output, the HVAC output, and a converter output.

Here, the driving output refers to a battery output used by a motor to drive the vehicle, which is determined by the driving output calculation unit 32 of the controller 30 at a high DTE vehicle speed or a low DTE vehicle speed that represent appropriate vehicle speeds for each regional condition and each road condition (S13 in FIG. 2), and accordingly, is input to the DTE calculation unit 35.

Furthermore, the HVAC output is determined by the HVAC output calculation unit 33 and is input to the DTE calculation unit 35, and the converter output is determined by the converter output calculation unit 34 and is input to the DTE calculation unit 35.

Here, the HVAC output refers to a battery output used for HVAC, the converter output refers to a battery output for electrical components, and the converter output may be an output of the LDC that converts battery power and outputs the result to the electrical components of the vehicle.

In the exemplary embodiment of the present disclosure, in the case of the HVAC output and the LDC output, there is no distinction between the low DTE value and the high DTE value, but in the case of the driving output, there is a distinction between the low DTE value and the high DTE value.

That is, the driving output includes a low DTE driving output and a high DTE driving output, in which the low DTE driving output is used to determine the low DTE total output by the DTE calculation unit 35, and the high DTE driving output is used to determine the total high DTE output by the DTE calculation unit 35 (S14 in FIG. 2).

The low DTE driving output and the high DTE driving output may be determined by an equation using the low DTE vehicle speed and the high DTE vehicle speed input from the vehicle speed calculation unit 31 as input variables, by the driving output calculation unit 32 of the controller 30.

This equation is a relational equation of “vehicle speed-driving output” that defines a correlation between the vehicle speed and the driving output, which may be a cubic equation.

Equation 3 represents a cubic equation for determining the driving output, that is, the low DTE driving output and the high DTE driving output based on the low DTE vehicle speed and the high DTE vehicle speed.

$$Driving output = {a}_{1} \times vehicle speed + {a}_{2} \times {( vehicle speed )}^{2} + {a}_{3} \times {( vehicle speed )}^{3} \qquad [ Equation 3 ]$$

Equation 3 is a cubic equation that represents a constant driving fuel economy curve, which may be determined by performing constant driving fuel economy tests and evaluations in a vehicle development stage for a corresponding vehicle type. Here, the cubic equation of “vehicle speed-driving output”, and the coefficients a₁, a₂, and a₃ of the cubic equation are obtained.

In Equation 3, the coefficients a₁, a₂, and a₃, which represent setting information for the equation of the constant driving fuel economy curve, are vehicle-predetermined values and represent characteristics of vehicle specifications.

In an exemplary embodiment of the present disclosure, the coefficients of the constant driving fuel economy curve are input and stored in advance in the driving output calculation unit 32 of the controller 30, and are used to determine the driving output through the equation of the constant driving fuel economy curve from an appropriate vehicle speed corresponding to the current regional conditions and road conditions.

In other words, the above coefficients may be used to determine the low DTE driving output and the high DTE driving output from the low DTE vehicle speed and the high DTE vehicle speed through the equation of the constant driving fuel economy curve.

Equation 4 and Equation 5 show cubic equations of the constant driving fuel economy curve for determining the low DTE driving output and the high DTE driving output from the low DTE vehicle speed and the high DTE vehicle speed.

$$Low DTE driving output = {a}_{1} \times ( low DTE vehicle speed ) + {a}_{2} \times {( low DTE vehicle speed )}^{2} + {a}_{3} \times {( low DTE vehicle speed )}^{3} \qquad [ Equation 4 ]$$

$$High DTE driving output = {a}_{1} \times ( high DTE vehicle speed ) + {a}_{2} \times {( high DTE vehicle speed )}^{2} + {a}_{3} \times {( high DTE vehicle speed )}^{3} \qquad [ Equation 5 ]$$

As described above, the low DTE total output and the high DTE total output, which correspond to the total battery output, may be determined by the DTE calculation unit 35 of the controller 30, as the sum of the driving output which is input from the driving output calculation unit 32 and the HVAC output which is input from the HVAC output calculation unit 33. The HVAC output may be determined by the HVAC calculation unit 33 through a known process of determining the HVAC output using an HVAC thermal model.

In the present way, the DTE calculation unit 35 of the controller 30 may be configured to determine the low DTE total output as the sum of the low DTE driving output and the HVAC output, and may be configured to determine the high DTE total output as the sum of the high DTE driving output and the HVAC output (S14 in FIG. 2).

Furthermore, the total output may be determined by further using the converter output, which corresponds to the battery output for the vehicle's electrical components. Here, the converter output which is input from the converter output calculation unit 34 may be the LDC output as described above.

Accordingly, the low DTE total output may be determined as the sum of the low DTE driving output, the HVAC output, and the LDC output, and the high DTE total output may be determined as the sum of the high DTE driving output, the HVAC output, and the LDC output, by the DTE calculation unit 35 of the controller 30 (S14 in FIG. 2).

In the exemplary embodiment of the present disclosure, as the LDC output, a learning value may be used. Here, a new LDC output value is stored in the converter output calculation unit 34 of the controller 30 for each predetermined driving distance of 1 km to learn a driver's personality.

That is, the converter output calculation unit 34 of the controller 30 has n (e.g., 25) buffers, and the LDC output value is stored in one buffer among the n buffers for each 1 km driving distance. Here, one of the values stored in the n buffers is updated with a new LDC output value every 1 km driving distance.

Furthermore, the LDC output values of the recently stored m (e.g., 10) buffers among the n values stored in the n buffers are averaged, and the average value may be used as the final LDC output value.

Table 2 shows a determination example of the LDC output values.

TABLE 2

| Buffer No. | 1 | 2 | . . . | 16 | 17 | 18 | 19 | 20 | 21 | 22 | 23 | 24 | 25 |
|---|---|---|---|---|---|---|---|---|---|---|---|---|---|
| LDC | 0.70 | 0.71 | . . . | 0.67 | 0.68 | 1.01 | 1.03 | 1.02 | 0.52 | 0.51 | 0.53 | 0.51 | 0.46 |
| output | | | | | | | | | | | | | |
| [kW] | | | | | | | | | | | | | |

In the example of Table 2, one LDC output value updated every preset driving distance (e.g., 1 km) is stored in each of 25 buffers, and the LDC output values of the 10 most-recently stored buffers among the sequentially stored 25 LDC output values are averaged, and the average value is used as the final LDC output value.

In the example of Table 2, 0.70 KW, which is the average value of the LDC output values stored in buffers 16 to 25, is determined as the final LDC output value.

In the present way, learning of the LDC output is performed, but since the LDC output is a relatively small value compared with the driving output and HVAC output, and a fluctuation range of the LDC output is also small, a fixed value, that is, a certain LDC output value set in advance for the vehicle may also be used as the LDC output value, instead of a value obtained by the learning.

After the low DTE total output and the total high DTE output are obtained through the above processes by the DTE calculation unit 35 of the controller 30, the low DTE value and the high DTE value may be obtained according to Equation 1 and Equation 2 (S15 in FIG. 2) using the low DTE vehicle speed and the high DTE vehicle speed input from the vehicle speed calculation unit 31, and the battery SoC input from the battery controller 20.

Table 3 shows an example of low DTEs and high DTEs obtained for different regional and road conditions for certain vehicles.

TABLE 3

| | Korea, Europe | | | | North America | | | |
|---|---|---|---|---|---|---|---|---|
| | Low | | High | | Low | | High | |
| | DTE | | DTE | | DTE | | DTE | |
| | vehicle | Low | vehicle | High | vehicle | Low | vehicle | High |
| | speed | DTE | speed | DTE | speed | DTE | speed | DTE |
| Highways | 120 | 274 | 80 | 415 | 130 | 244 | 90 | 379 |
| City roads | 100 | 343 | 60 | 466 | 110 | 307 | 70 | 445 |

In the present way, after the low DTE values and the high DTE values are determined, the display control unit 36 of the controller 30 is configured to control the operation of the display device 40 to display the low DTE value, the high DTE value, and the current DTE value according to a predetermined method (S16 in FIG. 2).

Here, the operation of the display device 40 may be controlled to display the low DTE values, the high DTE values, and the current DTE values as shown in FIG. 3A and FIG. 3B.

The current DTE value is determined based on a driver's driving tendency and a current vehicle driving state, and may be determined by a known method.

That is, any one of various methods that are known in the art to determine the current DTE value in real time using the driver's driving tendency related to acceleration and deceleration while driving and real-time driving state information such as driving road conditions such as ramps and a current vehicle speed may be used.

Since various methods of determining the current DTE in real time are known to those skilled in the art to which the present disclosure pertains, detailed description thereof will be omitted.

The display control unit 36 of the controller 30 is configured to control the operation of the display device 40 to display the current DTE value determined in the instant way together with the low DTE value and the high DTE value, as shown in FIG. 3A and FIG. 3B, for example.

According to the vehicle DTE display system and method according to the exemplary embodiments of the present disclosure, since the low DTE value and the high DTE value, as well as the current DTE value in which the driver's driving tendency and the current vehicle driving state are reflected, are displayed on the display device such as a cluster for the driver, it is possible to allow the current DTE value to move and converge toward the high DTE value, guiding the driver to efficiently drive the vehicle in terms of a fuel economy.

Furthermore, in a case where the current DTE value reaches the high DTE value, it is possible to display a correspondingly changed high DTE value.

Similarly, when efficient driving is not possible in terms of fuel economy, that is, when the current DTE value moves and converges toward the low DTE value, in a case where the current DTE value reaches the low DTE value, it is possible to display a correspondingly changed low DTE value.

To the present end, the controller 30 may be configured to determine a low fuel economy and a high fuel economy based on different current fuel economies, and store the results in a fuel economy map as shown in Table 4.

TABLE 4

| Fuel | Low fuel | Current | High fuel |
|---|---|---|---|
| economy | economy | fuel economy | economy |
| driving level | [km/kWh] | [km/kWh] | [km/kWh] |
| 1 | 5.8 | 7.2 | 8.6 |
| 2 | 4.8 | 6.0 | 7.2 |
| 3 | 4.0 | 5.0 (initial | |
| | | fuel economy) | 6.0 |
| 4 | 3.2 | 4.0 | 4.8 |
| 5 | 2.6 | 3.2 | 3.8 |

Here, a pre-stored fuel economy map in which the low and high fuel economies are sequentially arranged according to the first, second, third, fourth and fifth fuel economy driving levels depending on the current fuel economy is shown, but this is merely an example, and the present disclosure is not limited thereto. The low and high fuel economies depending on the current fuel economy may be provided based on a larger number of fuel economy driving levels. Furthermore, for example, the fuel economy driving levels may be displayed sequentially in various forms such as ECO+, ECO, NORMAL, SPORT, or SPORT+(N(GT)).

The controller 30 may be configured to determine the current DTE value, which is the real-time DTE according to the current fuel economy, based on the current battery SoC through the fuel economy map, and may be configured for controlling the operation of the display device 40 to determine and display the current DTE, low DTE, and high DTE (see FIG. 3A and FIG. 3B).

As described above, the controller 30 may be configured to determine the current DTE value, the low DTE value, and the high DTE value according to the above-mentioned Equations 1 and 2. For example, in a case where the current fuel economy is an initial fuel economy of 5.0 km/kWh, and the battery SoC is 100 kWh, and assuming that the low fuel economy and the high fuel economy include a 20% margin compared with the current fuel economy, “low fuel economy=initial fuel economy*0.8”, and “high fuel economy=initial fuel economy*1.2”. Accordingly, based on 100% SoC at initial factory shipment, the controller 30 may be configured to determine the low DTE value, the current DTE value, and the high DTE value as 400 km, 500 km, and 600 km, respectively (see Table 4).

The current DTE value, the low DTE value, and the high DTE value, together with normal display information, may be displayed on the vehicle cluster (see FIG. 3A and FIG. 3B).

The controller 30 is configured to perform control for selectively converting and displaying the low DTE value and the high DTE value as the current DTE value determined according to the current fuel economy during real-time driving reaches the low DTE value or the high DTE value determined with reference to the fuel economy map.

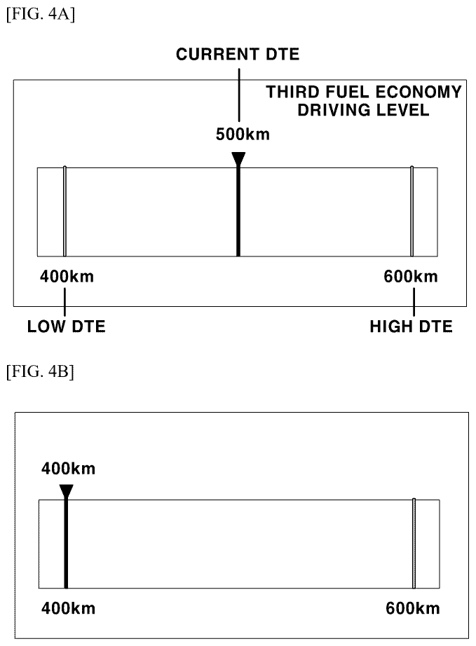

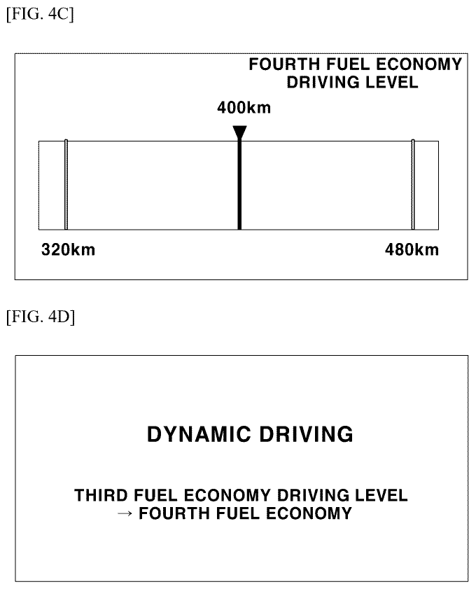

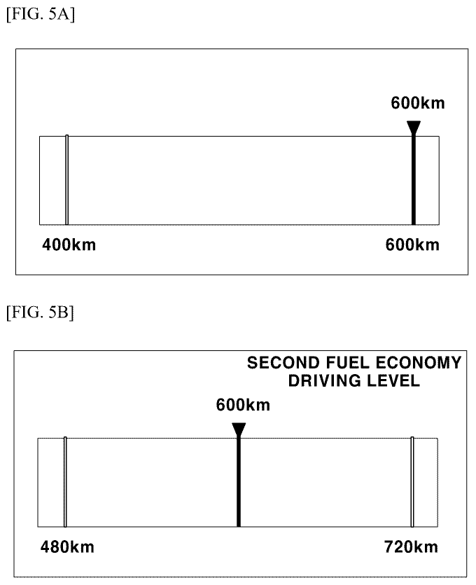

As a first example, with reference to the fuel economy map of Table 4 described above, in a state where the current fuel economy is 5.0 km/kWh corresponding to the third fuel economy driving level (NORMAL), and the current DTE value displayed according to the third fuel economy driving level is between 400 km and 600 km (see FIG. 4A), in a case where the current DTE value reaches the high DTE value of 600 km, as shown in FIG. 5A, the controller 30 is configured to perform control for converting the third fuel economy driving level (NORMAL) to the second fuel economy driving level (ECO) corresponding to a relatively efficient fuel economy driving section, that is, the low DTE value of 480 km and the high DTE value of 720 km, as shown in FIG. 5B, and displaying the result on the display device 40.

Here, the controller 30 may perform control for displaying a message “economic driving” as shown in FIG. 5C, together with the display of the converted fuel economy driving level, and furthermore, may perform control for displaying information related to the conversion state using one or more display methods among a display position, a size, and a color of a graphic.

According to the present example, by converting the fuel economy driving level to a higher fuel economy driving level based on a current vehicle driving state, adjusting a current DTE value to come between a low DTE value and a high DTE value corresponding to the converted fuel economy driving level, and displaying the result on the display device 40 such as a cluster in real time for a driver, it is possible to encourage the driver to drive a vehicle efficiently.

Furthermore, according to the present example, by further displaying information corresponding to the current fuel economy driving level in a set area such as an upper right section of the display device 40, it is possible for the driver to effectively and intuitively recognize which of the plurality of fuel economy driving levels a current vehicle driving state corresponds to.

As a second example, with reference to the fuel economy map of Table 4 described above, in a state where the current fuel economy is 6.0 km/kWh corresponding to the second fuel economy driving level (ECO), and the current DTE value displayed according to the second fuel economy driving level is between 480 km and 720 km, in a case where the current DTE value reaches the high DTE value of 720 km according to change in the current fuel economy, the controller 30 is configured to perform control for converting the second fuel economy driving level (ECO) into the first fuel economy driving level (ECO+) corresponding to a relatively efficient fuel economy driving section, that is, the low DTE value of 580 km and the high DTE value of 860 km, and displaying the result on the display device 40.

According to the present example, by converting the fuel economy driving level to a higher fuel economy driving level based on a current vehicle driving state, adjusting a current DTE value to come between a low DTE value and a high DTE value corresponding to the converted fuel economy driving level, and displaying the result on the display device 40 such as a cluster in real time for a driver, it is possible to encourage the driver to drive a vehicle efficiently.

Furthermore, according to the present example, by further displaying information corresponding to the current fuel economy driving level in a set area such as an upper right section of the display device 40, it is possible for the driver to effectively and intuitively recognize which of the plurality of fuel economy driving levels a current vehicle driving state corresponds to.

As a third example, with reference to the fuel economy map of Table 4 described above, in a state where the current fuel economy is 5.0 km/kWh corresponding to the third fuel economy driving level (NORMAL), and the current DTE value displayed according to the third fuel economy driving level is between 400 km and 600 km (see FIG. 4A), in a case where the current DTE value reaches the low DTE value of 400 km, as shown in FIG. 4B, the controller 30 is configured to perform control for converting the third fuel economy driving level (NORMAL) to the fourth fuel economy driving level (SPORT) corresponding to a relatively inefficient fuel economy driving section, that is, the low DTE value of 320 km and the high DTE value of 480 km, as shown in FIG. 4C, and displaying the result on the display device 40.

Here, the controller 30 may perform control for displaying a message “dynamic driving” as shown in FIG. 4D, together with the display of the converted fuel economy driving level, and furthermore, may perform control for displaying information related to the conversion state using one or more display methods among a display position, a size, and a color of a graphic.

According to the present example, by converting the fuel economy driving level to a lower fuel economy driving level based on a current vehicle driving state, adjusting a current DTE value to come between a low DTE value and a high DTE value corresponding to the converted fuel economy driving level, and displaying the result on the display device 40 such as a cluster in real time for a driver, it is possible to encourage the driver to perform fuel-efficient driving.

Furthermore, according to the present example, by further displaying information corresponding to the current fuel economy driving level in a set area such as an upper right section of the display device 40, it is possible for the driver to effectively and intuitively recognize which of the plurality of fuel economy driving levels a current vehicle driving state corresponds to.

As a fourth example, with reference to the fuel economy map of Table 4 described above, in a state where the current fuel economy is 4.0 km/kWh corresponding to the fourth fuel economy driving level (SPORT), and the current DTE value displayed according to the fourth fuel economy driving level is between 320 km and 480 km, in a case where the current DTE value reaches the low DTE value of 320 km according to change in the current fuel economy, the controller 30 is configured to perform control for converting the fourth fuel economy driving level to the fifth fuel economy driving level (SPORT+(N(GT)) corresponding to a relatively inefficient fuel economy driving section, that is, the low DTE value of 260 km and the high DTE value of 380 km, and displaying the result on the display device 40.

According to the present example, by converting the fuel economy driving level to a lower fuel economy driving level based on a current vehicle driving state, adjusting a current DTE value to come between a low DTE value and a high DTE value corresponding to the converted fuel economy driving level, and displaying the result on the display device 40 such as a cluster in real time for a driver, it is possible to encourage the driver to perform fuel-efficient driving.

Furthermore, according to the present example, by further displaying information corresponding to the current fuel economy driving level in a set area such as an upper right section of the display device 40, it is possible for the driver to effectively and intuitively recognize which of the plurality of fuel economy driving levels a current vehicle driving state corresponds to.

As a fifth example, the controller 30 is configured to perform control for continuously following and displaying the current DTE value in a case where the current vehicle driving state corresponds to the first fuel economy driving level (ECO+), that is, the set maximum fuel economy driving level, and the current DTE value reaches the high DTE value according to change in the current fuel economy.

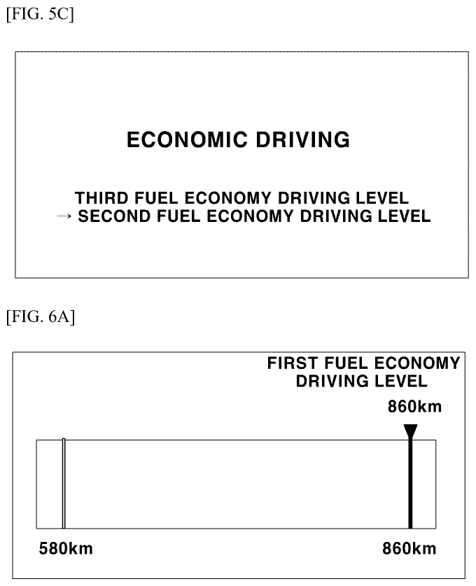

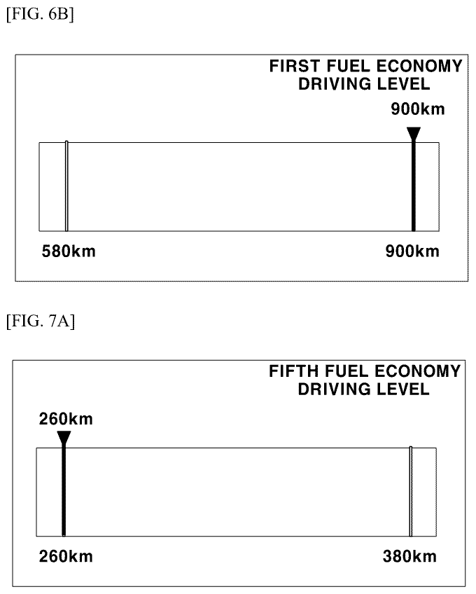

That is, with reference to the fuel economy map of Table 4 described above, in a state where the current fuel economy is 7.2 km/kWh corresponding to the first fuel economy driving level (ECO+), and the current DTE value displayed according to the first fuel economy driving level is between 580 km and 860 km (see FIG. 6A), in a case where the current DTE value reaches the high DTE value of 860 km, as shown in FIG. 6B, the controller 30 is configured to perform control for displaying the current DTE value corresponding to the current fuel economy in real time, for example, 900 km exceeding the high DTE value of the first fuel economy driving level (ECO+) on the display device 40.

According to the present example, during fuel-efficient driving exceeding a level set in the fuel economy map, the controller 30 may follow and display the corresponding current DTE value, encouraging the driver to continue fuel-efficient driving.

Here, during such continuous fuel-efficient driving, the controller 30 may output a message including corresponding information on the display device 40 in the same manner as in the above-described examples, and may perform control for displaying information related to the conversion state using one or more display methods among a display position, a size, and a color of a graphic.

As a sixth example, the controller 30 is configured to perform control for continuously following and displaying the current DTE value in a case where the current vehicle driving state corresponds to the fifth fuel economy driving level (SPORT+(N(GT)), that is, the set minimum fuel economy driving level, and the current DTE value reaches the low DTE value according to change in the current fuel economy.

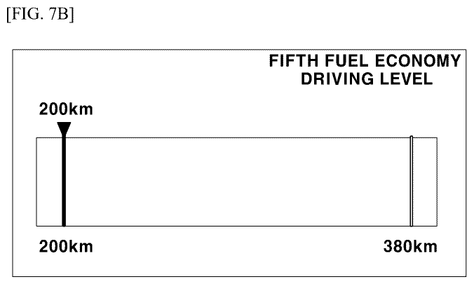

That is, with reference to the fuel economy map of Table 4 described above, in a state where the current fuel economy is 3.2 km/kWh corresponding to the fifth fuel economy driving level (SPORT+(N(GT)), and the current DTE value displayed according to the fifth fuel economy driving level is between 260 km and 380 km (see FIG. 7A), in a case where the current DTE value reaches the low DTE value of 260 km, as shown in FIG. 7B, the controller 30 is configured to perform control for displaying the current DTE value corresponding to the current fuel economy in real time, for example, 200 km lower than the low DTE value of the fifth fuel economy driving level (SPORT+(N(GT)) on the display device 40.

According to the present example, during fuel-inefficient driving lower than a level set in the fuel economy map, the controller 30 may follow and display the corresponding current DTE value, continuously providing information on the corresponding driving state to the driver.

Here, during such inefficient driving, the controller 30 may output a message including corresponding information on the display device 40 in the same manner as in the above-described examples, and may perform control for displaying information related to the conversion state using one or more display methods among a display position, a size, and a color of a graphic.

According to an exemplary embodiment of the present disclosure, by determining a low fuel economy and a high fuel economy for a plurality of different fuel economy driving levels with reference to a current fuel economy, inputting the results to a vehicle control unit (VCU), converting, in a case where a DTE based on the current fuel economy reaches a low DTE or a high DTE corresponding to the low fuel economy and the high fuel economy, the fuel economy driving level downward or upward, and outputting the low DTE and the high DTE at the converted fuel economy driving level, it is possible to continuously provide fuel economy guidance to a driver.

Furthermore, according to an exemplary embodiment of the present disclosure, for example, by outputting the low DTE and the high DTE at the upwardly converted fuel economy driving level through the display device for the driver in a case where the current DTE reaches the high DTE, and outputting the low DTE and the high DTE at the downwardly converted fuel economy driving level through the display device for the driver in a case where the current DTE reaches the low DTE, it is possible to encourage the driver to achieve fuel-efficient driving.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), silicon disk drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a predetermined operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described to explain certain principles of the present disclosure and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A vehicle Distance to Empty (DTE) information providing system comprising:
a display device that displays DTE information of a vehicle; and
a controller that is operatively connected to the display device and configured to control an operation of the display device,
wherein the controller is configured to determine low fuel economies and high fuel economies for different current fuel economies to store a result in a fuel economy map, to determine a current DTE value, which is a real-time DTE based on a current fuel economy, based on a current battery SOC value, to determine a low DTE value and a high DTE value of the current DTE value using the fuel economy map, and to display the result on the display device, and selectively converts the low DTE value and the high DTE value in a case where the current DTE value reaches the low DTE value or the high DTE value, and displays the result.

2. The system of claim 1, wherein the controller is further configured to determine the low fuel economy and the high fuel economy according to the current fuel economy based on first, second, third, fourth and fifth fuel economy driving levels sequentially arranged according to the current fuel economy, and to store the result in the fuel economy map.

3. The system of claim 2, wherein the controller is further configured to perform control for converting the third fuel economy driving level to the second fuel economy driving level, in a case where the current DTE value of the current fuel economy corresponding to the third fuel economy driving level reaches the high DTE value, and displaying the low DTE value and the high DTE value of the second fuel economy driving level on the display device.

4. The system of claim 3, wherein the controller is further configured to perform control for displaying information related to the a state of the conversion on the display device, in a case where the third fuel economy driving level is converted to the second fuel economy driving level.

5. The system of claim 4, wherein the controller is further configured to perform control for displaying the information related to the state of the conversion using one or more display methods among a message, a display position of a graphic, a size of the graphic, and a color of the graphic.

6. The system of claim 2, wherein the controller is further configured to perform control for converting the third fuel economy driving level to the fourth fuel economy driving level, in a case where the current DTE value of the current fuel economy corresponding to the third fuel economy driving level reaches the low DTE value, and displaying the low DTE value and the high DTE value of the fourth fuel economy driving level on the display device.

7. The system of claim 6, wherein the controller is further configured to perform control for displaying information related to a state of the conversion on the display device, in a case where the third fuel economy driving level is converted to the fourth fuel economy driving level.

8. The system of claim 7, wherein the controller is further configured to display the information related to the state of the conversion using one or more display methods among a message, a display position of a graphic, a size of the graphic, and a color of the graphic.

9. The system of claim 2, wherein the controller is configured to control the display device to follow and display the current DTE value, in a case where the current DTE value of the current fuel economy corresponding to the first fuel economy driving level reaches the high DTE value.

10. The system of claim 2, wherein the controller is configured to control the display device to follow and display the current DTE value, in a case where the current DTE value of the current fuel economy corresponding to the fifth fuel economy driving level reaches the low DTE value.

11. The system of claim 2, wherein the controller is further configured to control the display device to display which fuel economy driving level among the first, second, third, fourth and fifth fuel economy driving levels the current DTE value of the current fuel economy corresponds to.

12. A vehicle DTE information providing method, the method comprising:
determining, by a controller, low fuel economies and high fuel economies for different current fuel economies to store a result in a fuel economy map;
determining, by the controller, a current DTE value, which is a real-time DTE based on a current fuel economy, based on a current battery SOC value, determining a low DTE value and a high DTE value of the current DTE value using the fuel economy map, and displaying the result on a display device operatively connected to the controller; and
selectively converting the low DTE value and the high DTE value in a case where the current DTE value reaches the low DTE value or the high DTE value.

13. The method of claim 12, wherein the controller is further configured to determine the low fuel economy and the high fuel economy according to the current fuel economy based on first, second, third, fourth and fifth fuel economy driving levels sequentially arranged according to the current fuel economy, and to store the result in the fuel economy map.

14. The method of claim 13, wherein the converting of the low DTE value and the high DTE value includes:
performing, by the controller, control for converting the third fuel economy driving level to the second fuel economy driving level, in a case where the current DTE value of the current fuel economy corresponding to the third fuel economy driving level reaches the high DTE value, and displaying the low DTE value and the high DTE value of the second fuel economy driving level on the display device.

15. The method of claim 14, wherein the converting of the low DTE value and the high DTE value includes:
performing, by the controller, control for displaying information related to a state of the conversion on the display device, in a case where the third fuel economy driving level is converted to the second fuel economy driving level.

16. The method of claim 13, wherein the converting of the low DTE value and the high DTE value includes:
performing, by the controller, control for converting the third fuel economy driving level to the fourth fuel economy driving level, in a case where the current DTE value of the current fuel economy corresponding to the third fuel economy driving level reaches the low DTE value, and displaying the low DTE value and the high DTE value of the fourth fuel economy driving level on the display device.

17. The method of claim 16, wherein the converting of the low DTE value and the high DTE value includes:
performing, by the controller, control for displaying information related to a state of the conversion on the display device, in a case where the third fuel economy driving level is converted to the fourth fuel economy driving level.

18. The method of claim 13, wherein the converting of the low DTE value and the high DTE value includes:
controlling, by the controller, the display device to follow and display the current DTE value, in a case where the current DTE value of the current fuel economy corresponding to the first fuel economy driving level reaches the high DTE value.

19. The method of claim 13, wherein the converting of the low DTE value and the high DTE value includes:
controlling, by the controller, the display device to follow and display the current DTE value, in a case where the current DTE value of the current fuel economy corresponding to the fifth fuel economy driving level reaches the low DTE value.

20. The method of claim 13, wherein the converting of the low DTE value and the high DTE value includes:
controlling, by the controller, the display device to display which fuel economy driving level among the first, second, third, fourth and fifth fuel economy driving levels the current DTE value of the current fuel economy corresponds to.
